(19) United States
(12) Patent Application Publication
(10) Pub. No.: US 2012/0158623 A1
(43) Pub. Date: Jun. 21, 2012

(54) VISUALIZING MACHINE LEARNING ACCURACY

(75) Inventors: Mikhail Bilenko, Redmond, WA (US); Matthew Richardson, Seattle, WA (US)

(73) Assignee: MICROSOFT CORPORATION, Redmond, WA (US)

(21) Appl. No.: 12/973,916

(22) Filed: Dec. 21, 2010

(51) Int. Cl. G06F 15/18

(52) U.S. Cl. 706/12

(57) ABSTRACT

The claimed subject matter provides a method for visualizing machine learning accuracy. The method includes receiving a plurality of training instances for the machine learning system. The method also includes receiving a plurality of results for the machine learning system. The plurality of results corresponds to the plurality of training instances. The method further includes providing an interactive representation of the training instances and the results. The interactive representation supports identifying inaccuracies of the machine learning system attributable to the training instances, the features used to obtain a featurized form of the training instance, and/or a model implemented by the machine learning system.

### BACKGROUND

Machine learning involves executing algorithms that make predictions, and can be taught to change how those predictions are made using training data. However, deploying machine learning systems is a labor-intensive and heuristic process that typically proceeds by trial and error. An algorithm is run, and the results are analyzed. A user then decides which aspect of the system to modify to improve accuracy, and experiments with corresponding algorithms or system components.

For example, a common machine learning task involves spam filters. Spam filters may determine a probability that an incoming email message is spam, and label the email accordingly. When the filter incorrectly labels emails, the algorithm may be taught (through some modification) not to make the same mistake. These modifications are commonly referred to as accuracy debugging.

Machine learning systems provide various challenges. Accuracy debugging may be tedious, and involve experimentation with various facets of a machine learning system. Further, specialized tools are typically used for accuracy debugging due to the diversity of products and business settings for machine learning systems. As a result, the deployment of machine learning systems can be time consuming and resource-intensive.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for improving accuracy in a machine learning system. The method includes receiving a plurality of training instances for the machine learning system. The method also includes receiving a plurality of output results corresponding to predictions made by the machine learning system. The plurality of results corresponds to the plurality of training instances. The method further includes providing an interactive representation of the training instances and the results. The interactive representation supports identifying inaccuracies of the machine learning system. The inaccuracies may be attributable to the training instances, features used to obtain a featurized form of the training instances, and/or a model implemented by the machine learning system.

An exemplary system according to the subject innovation relates to a machine learning system. The exemplary system comprises a processing unit and a system memory that comprises code configured to direct the processing unit to receive a plurality of training instances for the machine learning system. Additional code stored by the system memory directs the processing unit to receive a plurality of results for the machine learning system, corresponding to the plurality of training instances. Code stored by the system memory additionally directs the processing unit to provide an interactive representation of the training instances and the results, wherein the interactive representation supports identifying inaccuracies of the machine learning system attributable to the training instances, the features used to obtain a featurized form of the training instance, and/or a model implemented by the machine learning system.

Another exemplary embodiment of the subject innovation provides one or more computer-readable storage media that include code to direct the operation of a processing unit. The code may direct the processing unit to receive a plurality of training instances for the machine learning system. The code may also direct the processing unit to receive a plurality of results for the machine learning system. The plurality of results correspond to the plurality of training instances. The code may further direct the processing unit to provide an interactive representation of the training instances and the results.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a system for visualizing learning accuracy in accordance with the claimed subject matter;

FIG. 2 is a process flow diagram of a method for improving accuracy in a machine learning system in accordance with the claimed subject matter.

FIG. 3 is a process flow diagram of a method for visualizing learning accuracy in accordance with the claimed subject matter;

FIG. 4 is a block diagram of an interface for visualizing learning accuracy in accordance with the claimed subject matter;

FIGS. 5A-5G are examples of interfaces for visualizing learning accuracy in accordance with the claimed subject matter;

FIG. 6 is a block diagram of an exemplary networking environment wherein aspects of the claimed subject matter can be employed; and

FIG. 7 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “machine learning system,” “visualization system,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Accuracy debugging may involve modifications to three typical components of machine learning systems: learning algorithm, training data, and a featurized training dataset. Either one or some combination of the three aspects may be modified to improve the learning accuracy of the machine learning system.

Machine learning applications typically utilize a model trained by a learning algorithm. For example, with spam filters, a nearest neighbor model may be used. The nearest neighbor model bases judgments regarding spam on the similarity of an incoming email to other emails known to be spam.

Typically, the model includes specific parameters for making these judgments, or other machine learning tasks. Accuracy debugging may involve modifications to these parameters.

Modifications to the training data may involve adding or removing sample cases, or changing assigned labels for sample cases. The featurized training dataset may include attributes, i.e., features, of the training data. These attributes may be specifically selected for their effect on the learning accuracy of the machine learning system. Accordingly, accuracy debugging may include adding, removing, or modifying attributes in the featurized training dataset.

The challenges in debugging the accuracy of machine learning systems may be attenuated by a visualization-based system for debugging accuracy that may be used to analyze these three components. The visualization-based system for debugging accuracy may be configured for application in various deployment scenarios.

The visualization-based system for debugging accuracy may also be domain-independent and model-independent, making the system usable with a broad range of learning algorithms and machine learning systems. Domain-independent accuracy visualization systems may be applied to various problems addressed in machine learning, such as spam filters, movie recommendations, etc. Model-independent accuracy visualization systems may incorporate the various algorithms used to solve the problems of the various domains, e.g, nearest neighbor models, decision trees and neural networks.

In some embodiments, the visualization-based system for debugging accuracy may include a single-suite tool that enables a user to analyze the various components of the machine learning system. Based on this analysis, the user may make corresponding modifications. Such embodiments may improve the practice of learning system deployment and accuracy debugging.

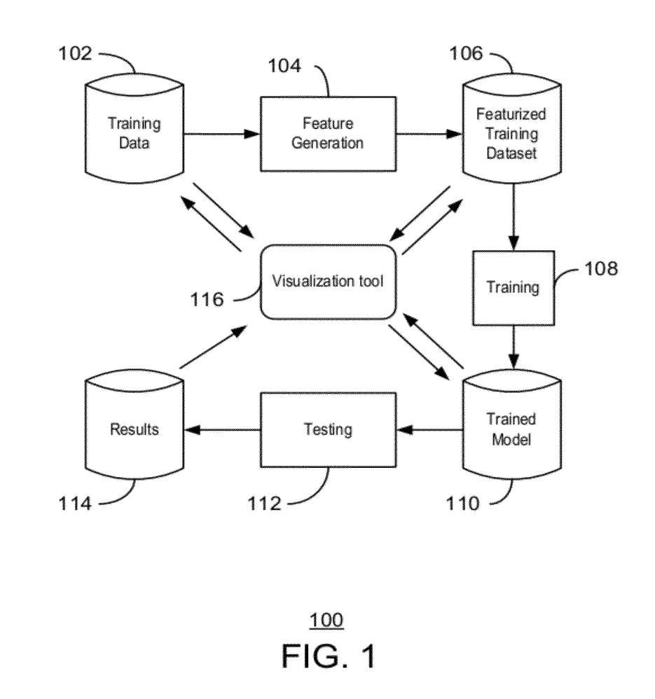

FIG. 1 is a block diagram of a visualization-based system for debugging accuracy 100 for machine learning systems in accordance with the claimed subject matter. The visualization-based system for debugging accuracy 100 may include a visualization tool 116 and various components of a machine learning system. As shown, the components of the machine learning system may include training data 102, a feature generation process 104, featurized training dataset 106, a training process 108, a trained model 110, a testing process 112, and results 114.

The training data 102 may be some collection of information that is used to train a machine learning system, such as sample emails for a spam filter. The training data 102 may be transformed into the featurized training dataset 106 by the feature generation process 104. The featurized training dataset 106 may include one instance for each instance in the training data 102. For example, the featurized training dataset 106 may include one instance for each sample email in the training data 102. Herein, the instances in the featurized training dataset 106 are also referred to as training instances.

Each training instance may include a corresponding label of a target variable, i.e., the value to be predicted. In an exemplary embodiment in which the machine learning system is a spam filter, the label may specify whether a sample email is spam. Labels may be used in other exemplary embodiments to represent characteristics or properties relevant to other specific applications. These labels may be used to determine the accuracy of the machine learning system's predictions.

The featurized training dataset 106 for a spam filter may be based on the content of the sample emails. Such content may be analyzed for keywords that indicate a likelihood of spam, e.g., names of prescription drugs or spam-related websites. Other attributes of the training data 102, such as addresses or routing information, may be included or excluded from the featurized training dataset 106.

The featurized training dataset 106 may be input to the training process 108 to produce the trained model 110. The training process 108 may be based on executing a machine learning algorithm, whereby parameters of the model may be tuned for accuracy.

In some exemplary embodiments, a subset of the featurized training dataset 106 may be reserved for the testing process 112, and not be input to the training process 108. A subset of the featurized training dataset 106 may also be reserved for a validation or development process. The trained model 110 may also be used in the testing process 112 to generate the results 114, which may include various accuracy statistics.

The visualization tool 116 may use the training data 102, the featurized training dataset 106, the trained model 110, and the results 114 to generate visualizations. For the trained model 110, the visualization tool 116 may use a set of model outputs, such as predicted values of the target variable (label). The model outputs may also include corresponding probability scores. The probability scores may indicate a confidence level that the predicted label values are accurate.

Using this data, the visualization tool 116 may be used to improve the learning accuracy by enabling the user to analyze each of three components of the machine learning system. Issues with the training data 102, the featurized training dataset 106, and the trained model 110 may be identified, and modified accordingly.

Issues with the training data may include erroneously labeled instances, or gaps in the training data 102. Both the training data 102 and the featurized training dataset 106 may be modified to add, remove or change the feature representation of the instances. Additionally, the visualizations may provide insight to issues with the trained model 110. Accordingly, the user may modify the trained model 110 with different parameters, or a different learning algorithm. The learning algorithm may identify model parameters, e.g., connection weights for neural networks.

In one embodiment, the visualization tool 116 may include an interface that enables a user to select visualizations for the machine learning system. The visualization tool 116 may provide a centralized interface that allows a user to select visualizations regarding different components of the machine learning system. In this way, the user may be enabled to perform analysis on multiple areas, thereby saving time and resources.

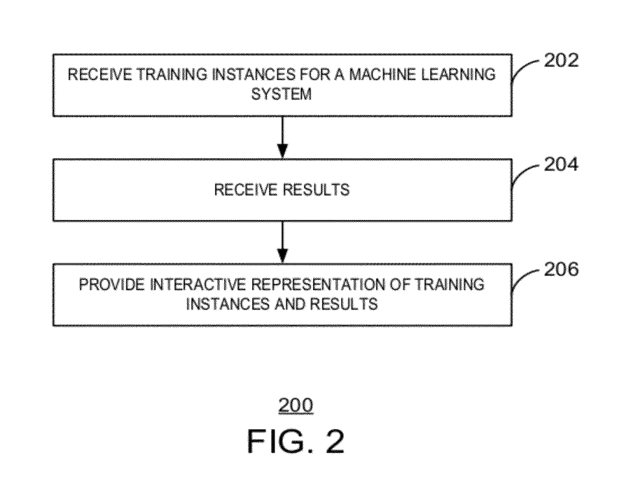

FIG. 2 is a process flow diagram of a method 200 for improving accuracy in a machine learning system in accordance with the claimed subject matter. The method 200 may be performed by the visualization tool 116. It should be understood that the process flow diagram is not intended to indicate a particular order of execution.

The exemplary method 200 begins at block 202, where the visualization tool 116 receives the training instances for the machine learning system. At block 204, the visualization tool 116 may receive the results 114 of the machine learning system. Each instance of the results 114 may correspond to one of the training instances.

At block 206, the visualization tool 116 may provide an interactive representation of the training instances and the results 114. The interactive representation may be a visualization based on the training instances and results 114. The interactive representation may enable the user to identify inaccuracies of the machine learning system. These inaccuracies may be attributable to the training instances, the features used to obtain the featurized form of the training instances, or the trained model 110. Subsequently, the user may identify ways to improve one or more of the three components.

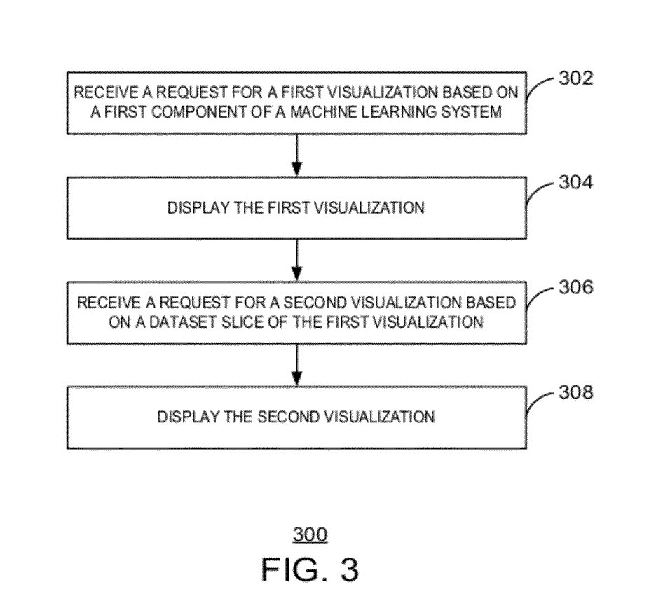

FIG. 3 is a process flow diagram of a method 300 for visualizing learning accuracy according to the claimed subject matter. The method 300 may be performed by the visualization tool 116. It should be understood that the process flow diagram is not intended to indicate a particular order of execution.

The exemplary method 300 begins at block 302, where the visualization tool 116 receives a request for a first visualization. The first visualization may be an interactive representation based on a first component of the machine learning system.

At block 304, the visualization tool 116 may display the first visualization. The visualization may provide a graphical comparison of accuracies and mistake analysis at various confidence levels. The visualization may incorporate the training data 102, featurized training dataset 106, trained model 110, the results 114, or some combination thereof.

At block 306, the visualization tool 116 may receive a request for a second visualization. The second visualization may be an interactive representation based on a second component of the machine learning system. The request may specify a dataset slice of the first visualization to be displayed in the second visualization.

A dataset slice may be a subset of data, e.g., a subset of the featurized training dataset 106, that the user may select for generating a second visualization. In one embodiment, an interface may enable the user to select a dataset slices formulaically or graphically.

Using a formulaic selection, the user may specify conditions using predicates, such as “feature1<0.5”, “label=1”, “label !=assignedLabel.” In one embodiment, an interface may include an entry field, within which the user may specify a formulaic selection predicate.

Selecting a subset of data graphically may involve a click and drag operation whereby items being displayed visually may be selected based on any visualization of the dataset or results obtained on it by a learned model. Alternatively, the dataset slice selection may be based on arbitrary criteria.

Such selections may allow identification of instances of interest, e.g., mislabeled training data 102, which may be selected according to highest confidence errors. Other instances of interest may include training instances where the predictions are inconsistent across different models. Such instances may be selected via disagreement points.

These selections may be used for subsequent application in the second visualization. Accordingly, at block 308, the second visualization may be displayed. The second visualization may be based on a second component of the machine learning system, which may differ from the first component.

The first and second visualizations may be selected from various options. Such options may include, but are not limited, to precision-recall curves, receiver operating characteristic curves, predicted value distribution plots for each label, confusion matrices and derived confusion difference matrices. Visualizations such as these may allow immediate comparison and contrast of the accuracy of different trained models 110. These visualizations may span a confidence range.

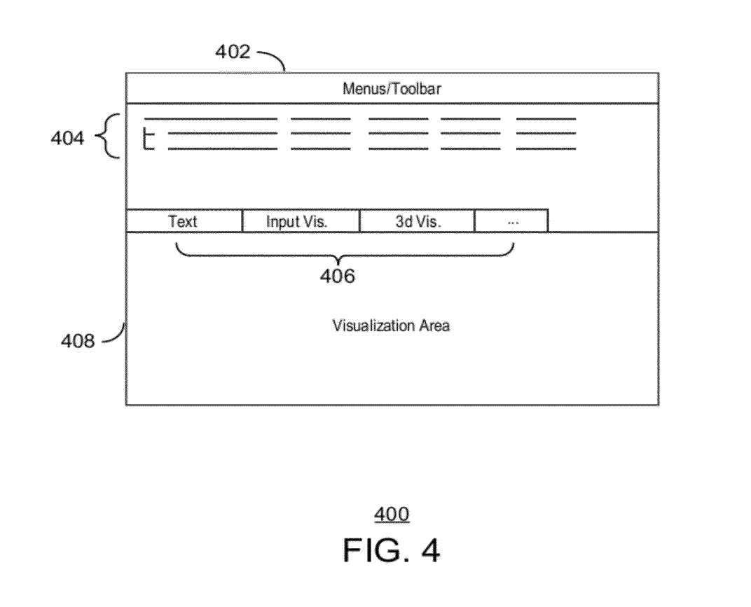

FIG. 4 is a block diagram of an interface 400 for visualizing learning accuracy in accordance with the claimed subject matter. The interface 400 includes a toolbar 402, dataset information 404, visualization options 406, and a visualization area 408. The toolbar 402 may include buttons that are clickable to perform various functions of the visualization tool 116. For example, some buttons may allow the user to load files for the training data 102, featurized training dataset 106, trained model 110, and results 114.

The dataset information 404 may include information about dataset slices in a particular visualization. In one embodiment, the dataset information 404 may include aggregate statistics about the dataset slice.

The visualization options 406 may include tabs for selecting the various visualizations available. For example, the “Text” tab may allow the user to view the training data, features, labels and scores produced by trained models. The “Input Vis.” Tab may allow the user to view 2-D or 3-D graphical visualization of data with dimensions and possibly other instance properties (e.g., color) corresponding to features, labels, scores and any derived quantities (e.g., derived features or model confidence scores). The visualization area 408 may include the selected visualization.

Visualizations provided according to the subject innovation may enable the user to compare various trained models 110. For example, a visualization may allow the user to compare the accuracy of the various trained models 110.

The interface 400 may also provide feature impact evaluation. With feature impact evaluation, the user may add or remove features from the featurized training dataset 106. In response, the interface 400 may show the impact of the corresponding modification on the predicted values and overall accuracy. For example, the user may select a new attribute to be added to the featurized training dataset. In response, the interface 400 may show a visualization of how the predicted values may change.

Further, the interface 400 may provide threshold impact evaluation. Typically, a threshold specifies a confidence level at which a positive prediction is made. For example, the machine learning system may predict that an email is spam at or above a 90% confidence level. Threshold impact evaluation may allow the user to specify a different confidence level, and show a visualization of how the predicted values change.

Visualizations provided according to the subject innovation may also show aggregations of statistics for the training instances. These visualizations may show distributions of values in the featurized training dataset 106. Further, outliers in the training instances may be flagged for further analysis. Providing the above capabilities in a single package that is independent of the underlying model may enable the user to view visualizations on arbitrary domains of machine learning systems.

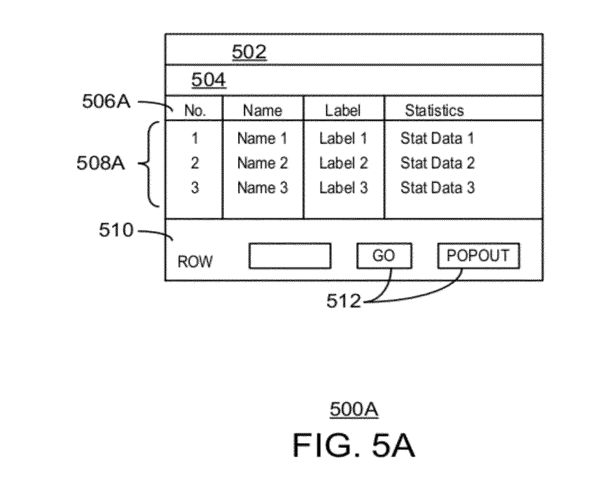

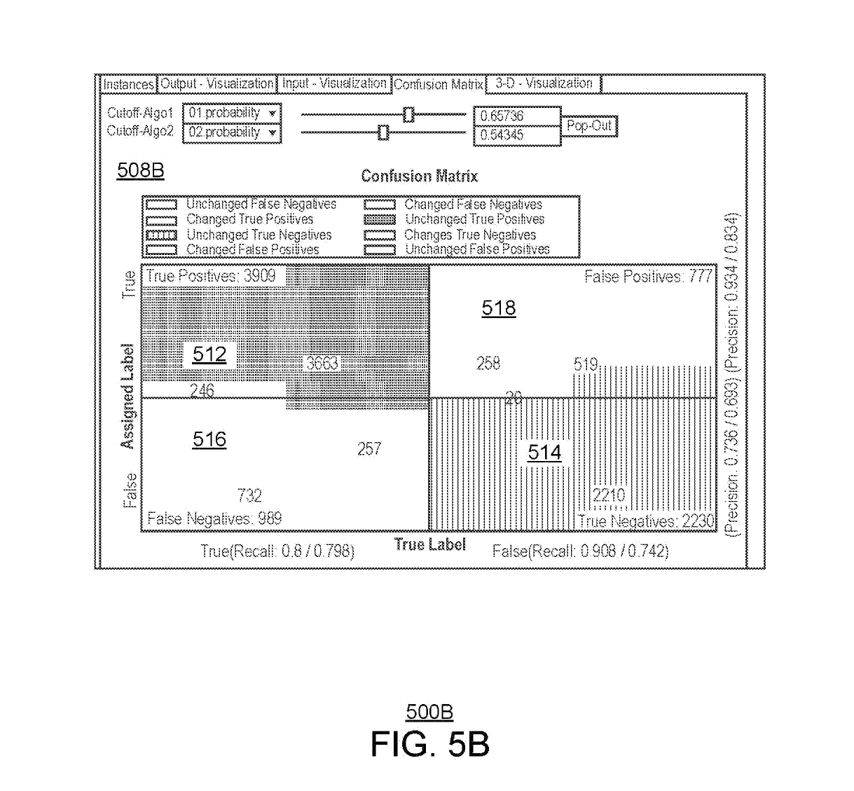

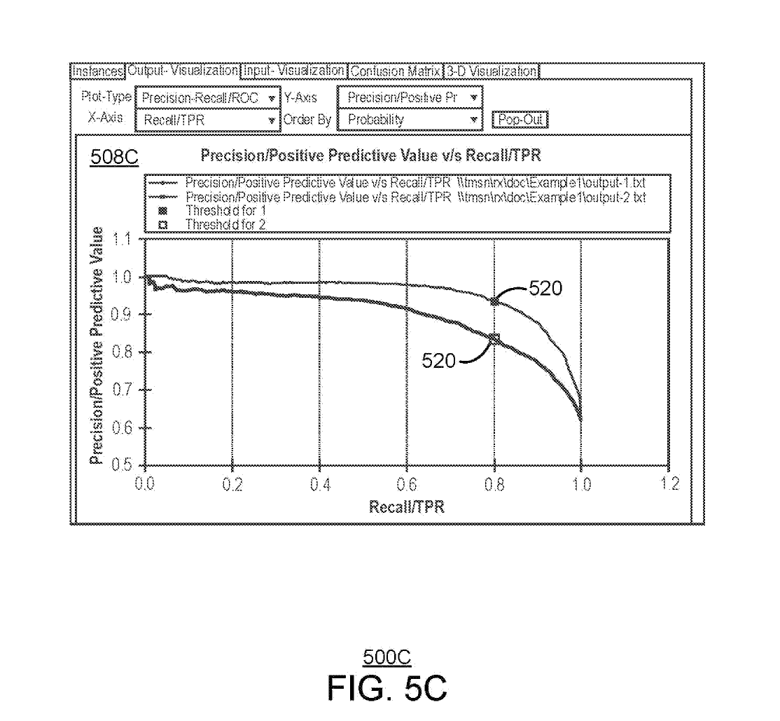

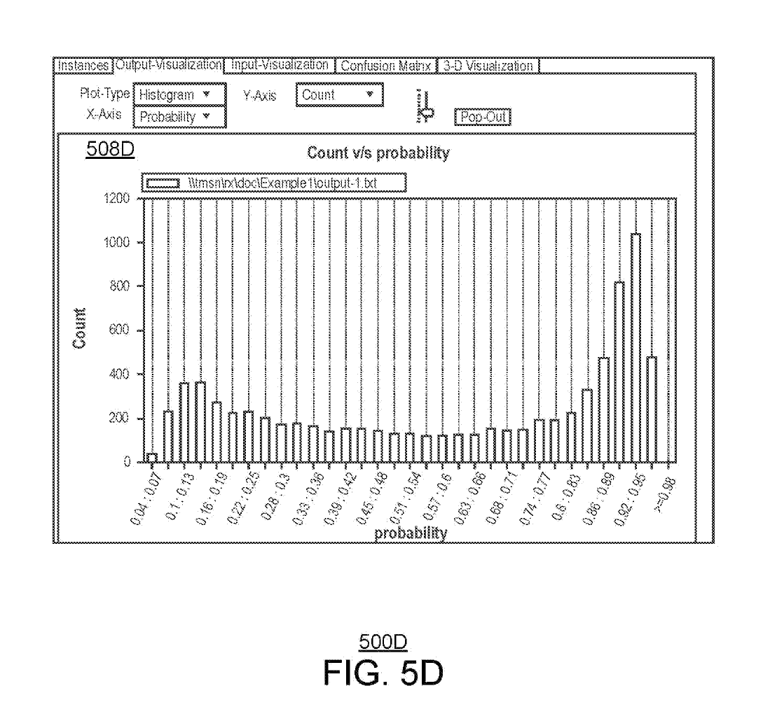

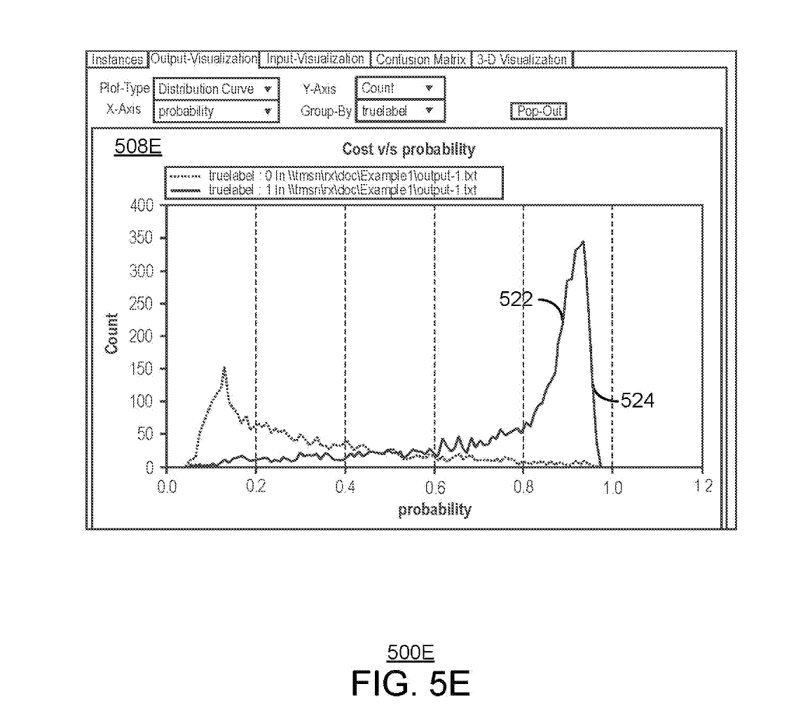

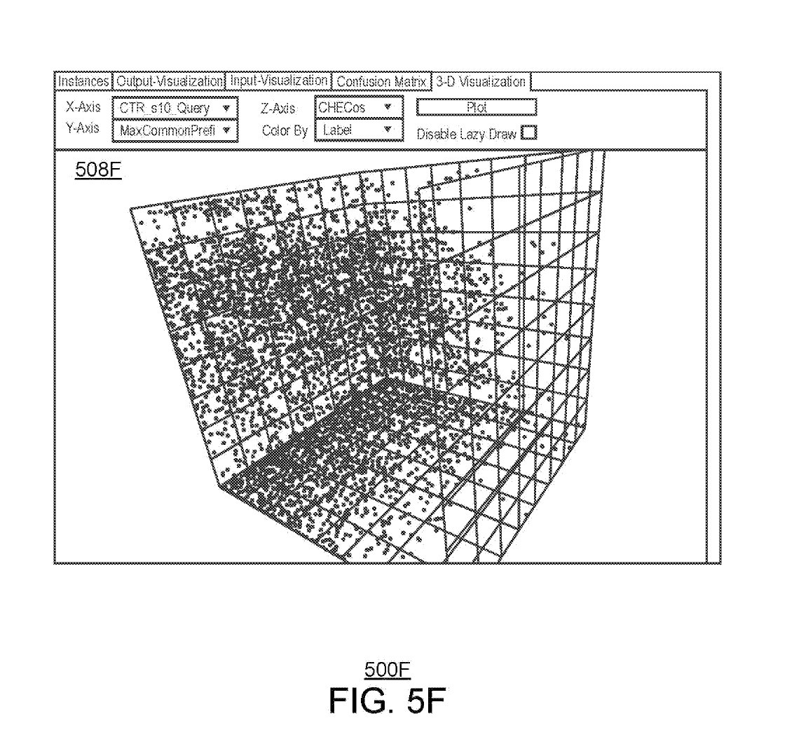

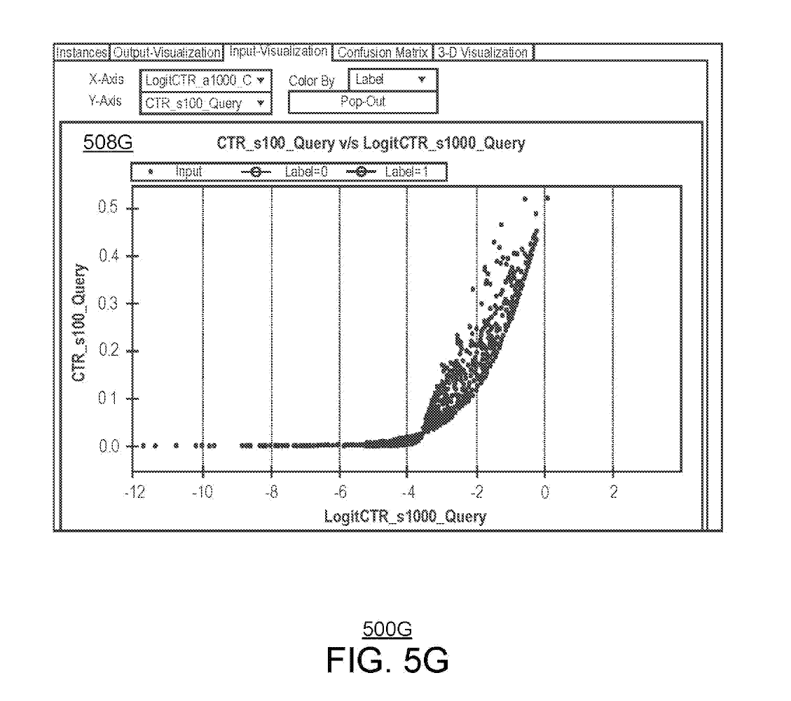

FIG. 5A is an example of an interface 500A for visualizing learning accuracy in accordance with the claimed subject matter. The interface 500A may include a toolbar 502A, dataset information 504A, visualization options 506A, and a visualization area 508A.

As shown, the visualization options 506A include columns for each row of the visualized data set slice. The columns include one for each of a number, (“NO.,”) “NAME,” “LABEL,” and “STATISTICS.”

The visualization area 508A includes a visualization of a slice of the featurized training dataset 106, with values for each of the columns, including aggregated statistics in the “STATISTICS” column.

As shown, the visualization area 508A also includes navigation region 510, with buttons 512. The navigation region may include field entry boxes and buttons 512 for view, and modify selected portions of the slice.

FIGS. 5B-5G are examples of interfaces 500B-500G for visualizing learning accuracy in accordance with the claimed subject matter. In particular, FIGS. 5B-5G show data for an exemplary embodiment of a machine learning system for filtering spam. Exemplary embodiments machine learning systems may be designed to perform a wide range of functions, and different visualizations of data relevant to such systems are within the scope of the subject innovation.

The visualization area 508B may include a confusion difference matrix. The confusion difference matrix may show various statistics about the classification accuracy for different models or algorithms. The statistics may show, in raw numbers, true positives 512, true negatives 514, false negatives 516, and false positives 518.

The true positives 512 may represent non-spam that was correctly identified. The true negatives 514 may be spam that was correctly identified. The false negatives 516 may represent may represent non-spam, incorrectly identified as spam. The false positives 518 may represent spam that was incorrectly identified as non-spam. Statistics may be determined to show the differences in each model. For example, the shaded areas may represent areas of disagreement between two models or algorithms.

The visualization area 508C may include a precision-recall or ROC (receiver operating characteristic) curves for a trained learning model. The x-axis of the precision recall curve represents a percent of spam detected by the machine learning system. The y-axis represents the prediction accuracy as a percentage of spam messages among messages labeled as spam. The precision recall curve may show a tradeoff between false positives and false negatives for a given featurized training dataset 106 and set of parameters in the trained model 110. In one embodiment, the user may select one or more points on the precision recall curve, corresponding to decision thresholds, and request a visualization corresponding to those points. For example, the points 520 may be selected as decision thresholds for visualization of a corresponding confusion matrix.

The visualization area 508D may include a count versus probability graph for the spam filter. The graph may represent a histogram of the results 114. The x-axis may represent ranges (buckets) of probability values, i.e., confidence levels, that emails are spam. The y-axis may represent the number of emails that fall in a given probability bucket. In one embodiment, the user may select one or more bars of the graph, and then request a visualization of the corresponding training data 102, featurized training dataset 106, or the scores produced by the trained model 110. Using this visualization may enable the user to determine why the confidence level is so low (or high, as the case may be).

The visualization area 508E includes two curves of the count versus probability graph in the visualization area 508D. The curve 522 may represent emails identified as spam. The curve 524 may represent emails identified as non-spam.

The visualization area 508F includes a three-dimensional plot of three features in the featurized training dataset 106. Each point in the plot may be colored, or otherwise labeled, to show the predicted or actual value of the target variable. In one embodiment, the interface 500F may provide the user with the ability to zoom in and out on the plot or rotate the coordinate system.

The visualization area 508G includes a scatter plot of the featurized training dataset 106. The x-axis may represent a first feature value, CTR_s100_Query. The y-axis may represent a second feature value, LogitCTR_s1000_Query. The scatter plot may enable the user to determine relationships between the features of the featurized training dataset.

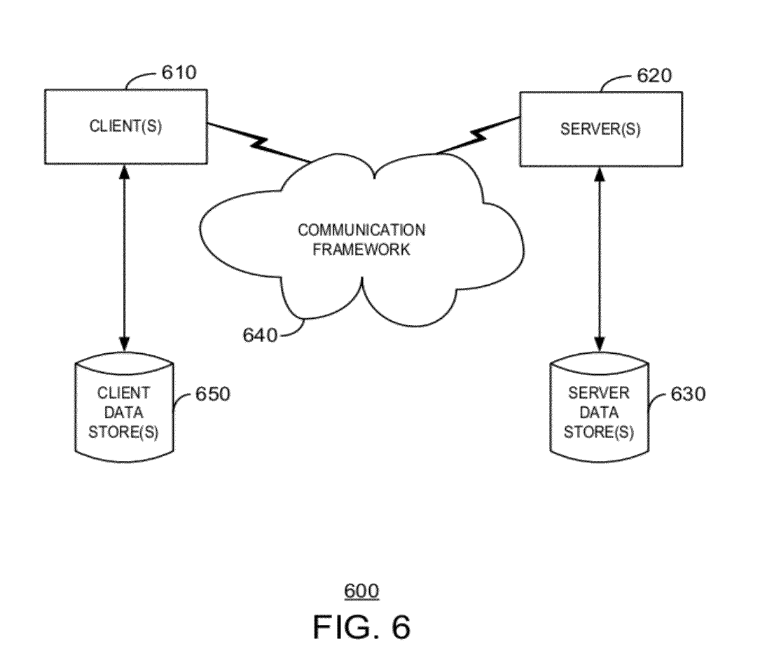

FIG. 6 is a block diagram of an exemplary networking environment 600 wherein aspects of the claimed subject matter can be employed. Moreover, the exemplary networking environment 600 may be used to implement a system and method of visualizing machine learning accuracy.

The networking environment 600 includes one or more client(s) 610. The client(s) 610 can be hardware and/or software (e.g., threads, processes, computing devices). As an example, the client(s) 610 may be computers providing access to servers over a communication framework 640, such as the Internet.

The networking environment 600 also includes one or more server(s) 620. The server(s) 620 can be hardware and/or software (e.g., threads, processes, computing devices). Further, the server(s) may be accessed by the client(s) 610. The servers 620 can house threads to support a machine learning system. The servers 620 may also house threads to provide visualizations of machine learning accuracy to client(s) 610.

One possible communication between a client 610 and a server 620 can be in the form of a data packet adapted to be transmitted between two or more computer processes. The networking environment 600 includes a communication framework 640 that can be employed to facilitate communications between the client(s) 610 and the server(s) 620.

The client(s) 610 are operably connected to one or more client data store(s) 650 that can be employed to store information local to the client(s) 610. The client data store(s) 650 may be located in the client(s) 610, or remotely, such as in a cloud server. Similarly, the server(s) 620 are operably connected to one or more server data store(s) 630 that can be employed to store information local to the servers 620.

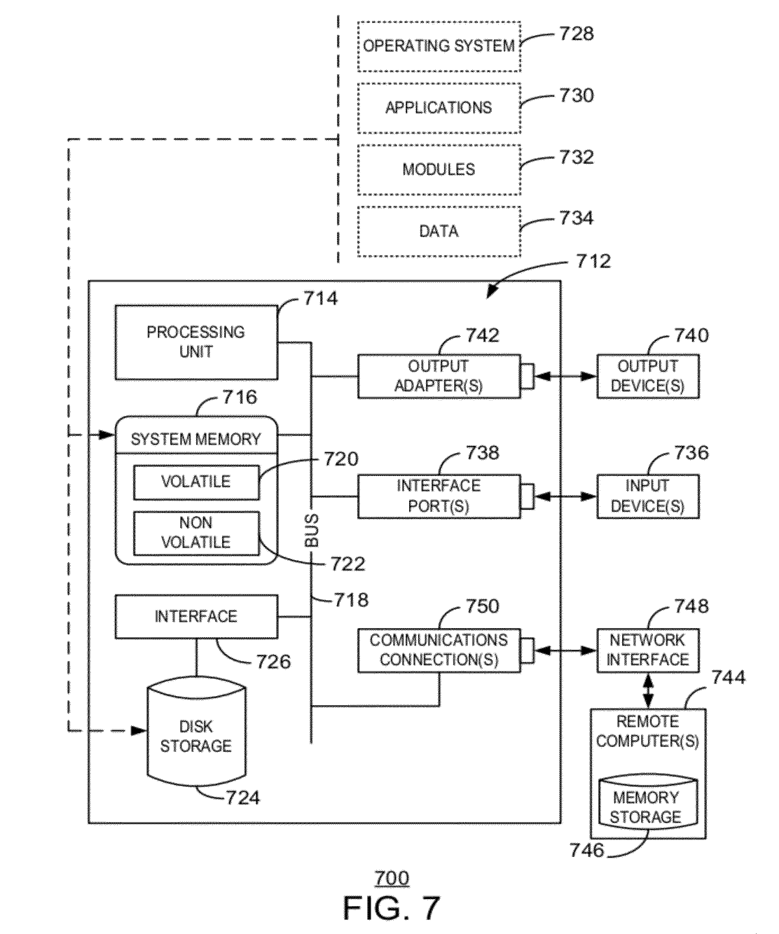

With reference to FIG. 7, an exemplary operating environment 700 for implementing various aspects of the claimed subject matter. The exemplary operating environment 700 includes a computer 712. The computer 712 includes a processing unit 714, a system memory 716, and a system bus 718.

The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures known to those of ordinary skill in the art. The system memory 716 is non-transitory computer-readable media that includes volatile memory 720 and nonvolatile memory 722.

The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable programmable ROM (EEPROM), or flash memory.

Volatile memory 720 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 712 also includes other non-transitory computer-readable media, such as removable/non-removable, volatile/non-volatile computer storage media. FIG. 7 shows, for example a disk storage 724. Disk storage 724 includes, but is not limited to, devices like a magnetic disk drive, floppy disk drive, tape drive, Jaz drive, Zip drive, LS-100 drive, flash memory card, or memory stick.

In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in the suitable operating environment 700. Such software includes an operating system 728. Operating system 728, which can be stored on disk storage 724, acts to control and allocate resources of the computer system 712.

System applications 730 take advantage of the management of resources by operating system 728 through program modules 732 and program data 734 stored either in system memory 716 or on disk storage 724. It is to be appreciated that the claimed subject matter can be implemented with various operating systems or combinations of operating systems.

A user enters commands or information into the computer 712 through input device(s) 736. Input devices 736 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 736 connect to the processing unit 714 through the system bus 718 via interface port(s) 738. Interface port(s) 738 include, for example, a serial port, a parallel port, a game port, and a universal serial bus (USB).

Output device(s) 740 use some of the same type of ports as input device(s) 736. Thus, for example, a USB port may be used to provide input to the computer 712, and to output information from computer 712 to an output device 740.

Output adapter 742 is provided to illustrate that there are some output devices 740 like monitors, speakers, and printers, among other output devices 740, which are accessible via adapters. The output adapters 742 include, by way of illustration and not limitation, video and sound cards that provide a means of connection between the output device 740 and the system bus 718. It can be noted that other devices and/or systems of devices provide both input and output capabilities such as remote computer(s) 744.

The computer 712 can be a server hosting a machine learning system in a networked environment using logical connections to one or more remote computers, such as remote computer(s) 744. The remote computer(s) 744 may be client systems configured with web browsers, PC applications, mobile phone applications, and the like, to allow users to request and view visualizations of machine learning accuracy, as discussed herein.

The remote computer(s) 744 can be a personal computer, a server, a router, a network PC, a workstation, a microprocessor based appliance, a mobile phone, a peer device or other common network node and the like, and typically includes many or all of the elements described relative to the computer 712.

For purposes of brevity, only a memory storage device 746 is illustrated with remote computer(s) 744. Remote computer(s) 744 is logically connected to the computer 712 through a network interface 748 and then physically connected via a communication connection 750.

Network interface 748 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to the computer 712. The hardware/software for connection to the network interface 748 may include, for exemplary purposes only, internal and external technologies such as, mobile phone switches, modems including regular telephone grade modems, cable modems and DSL modems, ISDN adapters, and Ethernet cards.

An exemplary embodiment of the computer 712 may comprise a server hosting a machine learning system. The server may be configured to provide visualizations of machine learning accuracy in response to requests from a user.

An exemplary processing unit 714 for the server may be a computing cluster comprising Intel® Xeon CPUs. The disk storage 724 may comprise an enterprise data storage system, for example, holding thousands of impressions.

Exemplary embodiments of the subject innovation may display a visualization for a machine learning system. A dataset slice may be selected from the visualization. A second visualization may be generated and provided to the remote computer(s) 744.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for improving accuracy in a machine learning system, comprising:
receiving a plurality of training instances for the machine learning system;
receiving a plurality of results for the machine learning system, corresponding to the plurality of training instances; and
providing an interactive representation of the training instances and the results, wherein the interactive representation supports identifying inaccuracies of the machine learning system attributable to the training instances, the features used to obtain a featurized form of the training instance, and/or a model implemented by the machine learning system.

2. The method recited in claim 1, comprising modifying the machine learning system to improve performance based on training instances, the features used to obtain a featurized form of the training instance, and/or a model implemented by the machine learning system.

3. The method recited in claim 1, wherein the plurality of training instances comprise a featurized training dataset for a corresponding plurality of training data.

4. The method recited in claim 1, wherein providing the interactive representation comprises receiving a request for a dataset slice of the interactive representation and another component of the machine learning system.

5. The method recited in claim 4, wherein the dataset slice comprises one of:
a graphical selection of one or more data points in the interactive representation;
a formulaic specification that selects the one or more data points; or
combinations thereof.

6. The method recited in claim 1, wherein the interactive representation comprises:
a precision recall curve; a receiver operating characteristic (ROC) curve;
a prediction distribution plot for the model;
a confusion matrix;
an aggregation of feature statistics;
a derived confusion difference matrix;
a feature impact evaluation; or
a threshold impact evaluation.

7. The method recited in claim 1, comprising displaying an interface that comprises:
an icon configured to request the interactive representation; and
an icon configured to request a modification to the machine learning system.

8. The method recited in claim 7, wherein the interface comprises an entry field wherein a formulaic selection predicate may be entered, and wherein a dataset slice is selected based on the formulaic selection predicate.

9. A machine learning system, comprising:
a processing unit; and
a system memory, wherein the system memory comprises code configured to direct the processing unit to:
receive a plurality of training instances for the machine learning system;
receive a plurality of results for the machine learning system, corresponding to the plurality of training instances; and
provide an interactive representation of the training instances and the results, wherein the interactive representation supports identifying inaccuracies of the machine learning system attributable to the training instances, the features used to obtain a featurized form of the training instance, and/or a model implemented by the machine learning system.

10. The system recited in claim 9, wherein the plurality of training instances comprise a featurized training dataset for a corresponding plurality of training data.

11. The system recited in claim 9, wherein the code configured to direct the processing unit to provide the interactive representation comprises code configured to direct the processing unit to receive a request for a dataset slice of the interactive representation and another component of the machine learning system.

12. The system recited in claim 11, wherein the selection comprises one of:
a graphical selection of one or more data points in the interactive representation;
a formulaic specification that selects the one or more data points; or
combinations thereof.

13. The system recited in claim 11, wherein a dataset slice is selected that comprises a specified selection of data represented in the interactive representation.

14. The system recited in claim 13, wherein the specified selection comprises one of:
a graphical selection of one or more data points in the interactive representation;
a formulaic specification that selects the one or more data points; or
combinations thereof.

15. The system recited in claim 11, wherein the system memory comprises code configured to direct the processing unit to display an interface that comprises:
an icon configured to request the interactive representation; and
an icon configured to request a modification to the machine learning system.

16. One or more computer-readable storage media, comprising code configured to direct a processing unit to:
receive a plurality of training instances for the machine learning system;
receive a plurality of results for the machine learning system, corresponding to the plurality of training instances; and
provide an interactive representation of the training instances and the results, wherein the interactive representation supports identifying inaccuracies of the machine learning system attributable to the training instances, the features used to obtain a featurized form of the training instance, and/or a model implemented by the machine learning system.

17. The computer-readable storage media of claim 16, wherein the code configured to direct the processing unit to provide the interactive representation comprises code configured to direct a processing unit to receive a request for a dataset slice of the interactive representation and another component of the machine learning system.

18. The computer-readable storage media of claim 16, wherein the interactive representation comprises one of:
a precision recall curve;
a receiver operating characteristic curve;
a prediction distribution plot for the model;
a confusion matrix; or
an aggregation of feature statistics.

19. The computer-readable storage media of claim 18, wherein the interactive representation comprises one of:
a derived confusion difference matrix;
a feature impact evaluation; or
a threshold impact evaluation.

20. The computer-readable storage media of claim 16, wherein the code is configured to direct the processing unit to display an interface that comprises:
an icon configured to select the interactive representation; and
an icon configured to request a modification to the machine learning system.
